(19) United States
(12) Patent Application Publication
(10) Pub. No.: US 2010/0078954 A1
(43) Pub. Date: Apr. 1, 2010

(54) Vehicle Console

(75) Inventors: Frank Qiukui Liu, Canton, MI (US); Mark Allen Turner, Wixom, MI (US)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/241,739

(22) Filed: Sep. 30, 2008

(51) Int. Cl. B60R 7/04; B60R 11/00; B60R 99/00; B60N 3/00

(52) U.S. Cl. 296/24.34; 296/37.8

(57) ABSTRACT

A vehicle console that simultaneously provides console features to multiple rows of occupants in a vehicle. The console includes a fixed portion that is secured to the base of the vehicle. The fixed portion includes at least one fixed console feature. The console further includes a sliding portion that is slidably mounted within the fixed portion. The sliding portion engages the fixed portion to slide in and out of the fixed portion as fixed portion remains stationary on the base. The sliding portion moves longitudinal along the base as it extends from the fixed portion. The sliding portion includes at least one sliding console feature.

### BACKGROUND OF THE INVENTION

1. Field of the Invention

The subject invention relates to a center console for simultaneously providing console features to multiple rows of occupants of a vehicle.

2. Description of the Prior Art

The use of center consoles in vehicles has been known for many years. In many systems, the center consoles are fixed in a single location. For example, it is well known to provide a center console between the driver and front passenger seats in an automotive vehicle. These consoles have many functions. It may operate as an armrest and may include instruments, gauges, storage compartments, cup holders, ashtrays, as well as functional devices such as the gear shift lever, the parking brake actuator, side window adjusters, power points, USB, MP3, and other audio/video ports, etc. It is also known to use these center consoles to store items such as coins, CD's and other personal items used by the driver or other vehicle occupants.

Current center consoles lack user friendliness in a variety of areas. For example, while drivers and occupants located in the front row have access to the many features of the center console, the occupants in the other rows do not have the access to these console features. As stated above, the center console is typically fixed to the base of the vehicle, which limits the use of the console features to the row in which the center console is positioned.

One solution to the above issue known in the art is to add tracks on the vehicle base or floor pan of the vehicle in which the entire center console slides in the fore and aft directions on the tracks. This solution allows either front occupants or rear occupants, but not both, to access the console features separately when it slides longitudinally toward the front or rear rows. Again, use of the console features are limited to a single row of occupants. Additionally, tracks are problematic in that objects could fall inside the exposed tracks attached to the vehicle base, which could cause malfunction of the track system. For example, the tracks can become clogged with dirt and debris causing malfunction or sticking when moving the center console in a fore or aft direction. The addition of tracks also adds time during the manufacture of the vehicle for additional installation steps.

As such, it would be desirable to have an improved center console that could simultaneously provide the features of the center console to multiple rows of occupants in a vehicle.

### SUMMARY OF THE INVENTION AND ADVANTAGES

The present invention solves the above described problems as well as other problems by providing a console that simultaneously provides console features to multiple rows of occupants in a vehicle. The console includes a fixed portion that is secured to the base or floor of the vehicle. The fixed portion includes at least one fixed console feature. The console further includes a sliding portion that is slidably mounted within the fixed portion, and without the need for tracks attached to the base or floor of the vehicle. The sliding portion engages the fixed portion to slide in and out of the fixed portion as the fixed portion remains stationary relative to the base. The sliding portion moves longitudinal along the base or in line with the direction of travel of the vehicle as it extends from the fixed portion. The sliding portion includes at least one sliding console feature. Thus, the console features are available to occupants of more rows of seats.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

Other advantages of the present invention will be readily appreciated and more fully understood by reference to the following detailed description when considered in connection with the accompanying drawing wherein:

FIG. 1 is a top plan view of a prior art sliding center console disposed between the seats of a chicle and being moveable along a track;

FIG. 2 is a top plan view of an exemplary console in accordance with the invention disposed in a vehicle;

FIG. 3 is a perspective view of an exemplary console in accordance with the invention.

FIG. 4 is a perspective view of an exemplary console in accordance with the invention.

FIG. 5 is a perspective view of an exemplary console in accordance with the invention.

FIG. 6 is a perspective view of an exemplary console in accordance with the invention.

FIG. 7 is a bottom perspective view of an exemplary console in accordance with the invention:

FIG. 8 is a partial perspective view of the bottom of the exemplary console as shown in FIG. 7;

FIG. 9 is a perspective view of an exemplary console in accordance with the invention.

FIG. 10 is a perspective view of an exemplary console in accordance with the invention: and

FIG. 11 is a perspective view of an exemplary console in accordance with the invention.

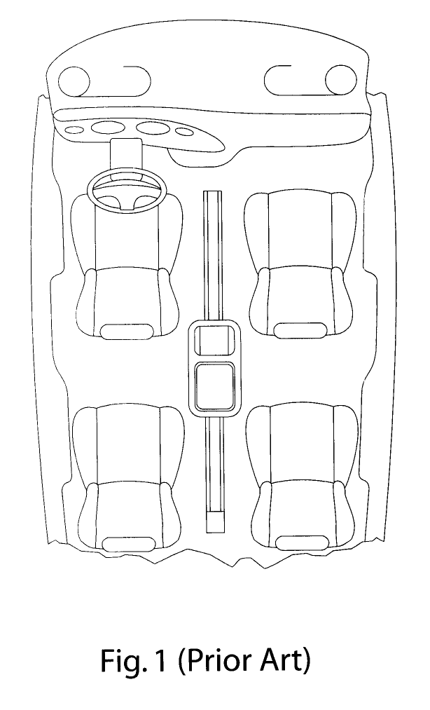

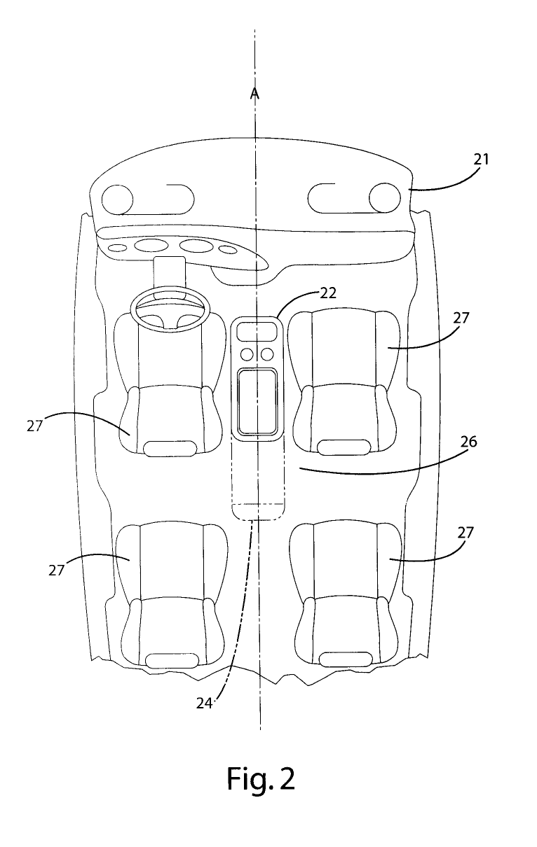

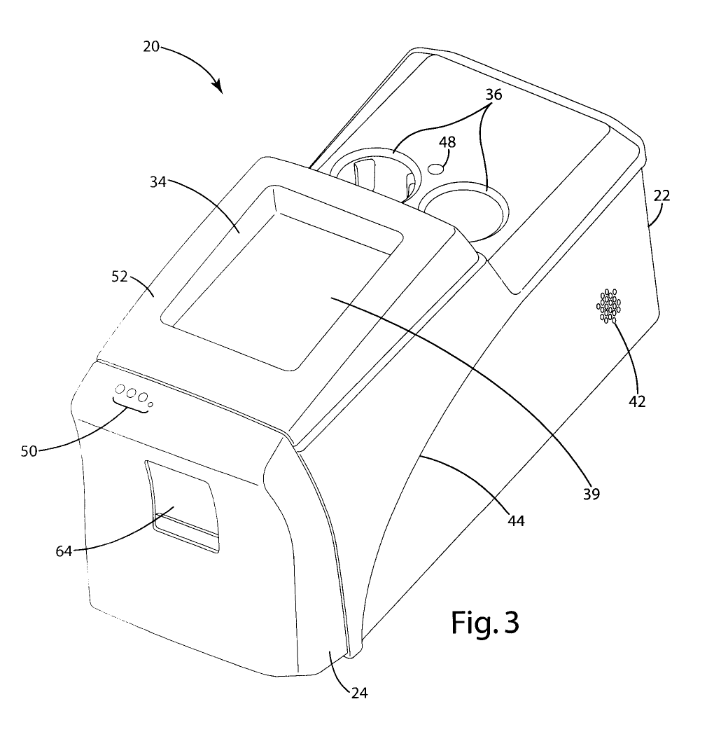

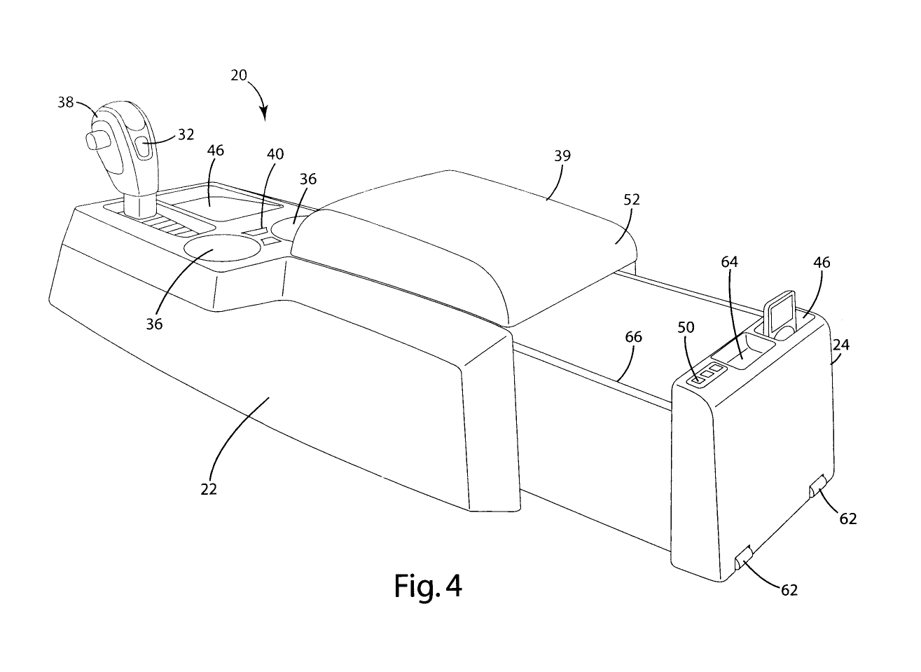

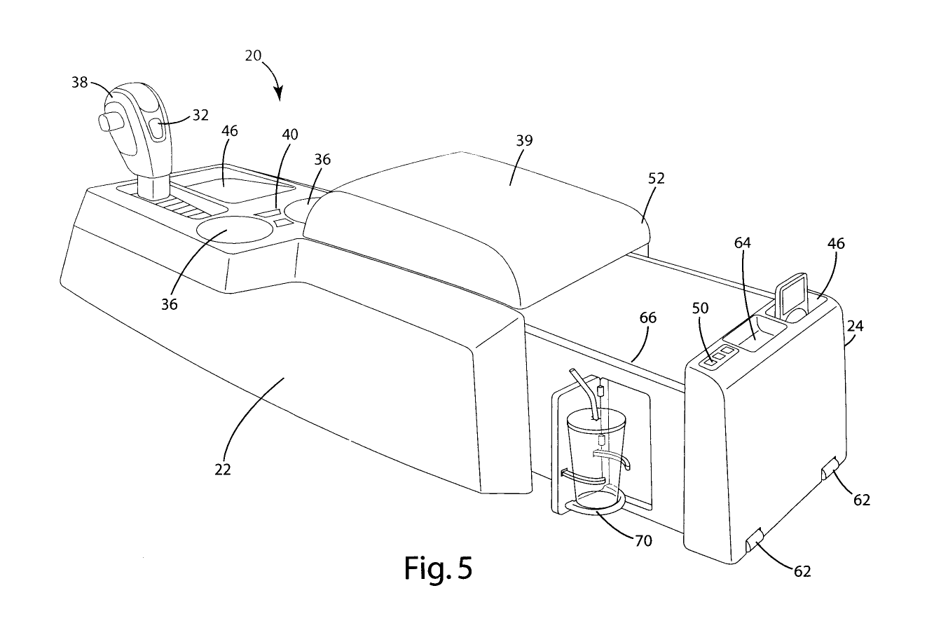

### DETAILED DESCRIPTION OF THE INVENTION

Referring to the Figures, wherein like numerals indicate corresponding parts throughout the several views, a console 20 is generally shown for providing console features simultaneously to multiple rows of occupants of a vehicle 21. The vehicle 21 can be any transportation vehicle 21 known in the art, including but not limited to, automobiles, planes and trains. The vehicle 21 generally includes a body structure having a base 26 or floor to which components of the vehicle 21 are attached. Such components include, but are not limited to the vehicle seats 27 and the console 20 of the present invention. The vehicle 21 generally has a longitudinal axis A extending approximately along the length of the vehicle 21, which is also commonly in the direction of travel. The base 26 or floor of the vehicle 21 is commonly covered by a surface material, such as carpet.

Although the figures illustrate the console 20 as a center console 20 arranged along or aligned with the longitudinal axis A. Other configurations, locations and directional arrangements may be used. The console 20 of the present invention includes a fixed portion 22 and a sliding portion 24. The sliding portion 24 engages with or is coupled to the fixed portion 22 to slide in and out of the fixed portion 22 as fixed portion 22 remains stationary on the base 26. This allows console features to be available to multiple rows of occupants of a vehicle 21.

The fixed portion 22 is secured to the base 26 of the vehicle 21. The fixed portion 22 is manufactured from materials generally known in the art, such as vinyl, leather, metal, cloth, or plastic. The fixed portion 22 is generally secured to the base 26 between the front seats 27 of an automobile. The sliding portion 24 would be slidable to at least the row immediately behind the row in which the fixed portion 22 is located.

The fixed portion 22 may be fixed to the base 26 by any attachment means known in the art. In the exemplary embodiment, the fixed portion 22 includes latches 28 extending from the bottom of the fixed portion 22 that engage the base 26 or a cooperating member (not illustrated) that is secured to the base 26 to secure the fixed portion 22 to the base 26. If the console 20 includes electrical features, the fixed portion 22 may further include an electrical connector 30 that extends from the bottom of the fixed portion 22 and engages a cooperating electrical connector 30 extending from the vehicle 21 to provide power to the fixed portion 22.

The fixed portion 22 includes at least one fixed console feature. Fixed console features include instruments 32, storage compartments 34, cup holders 36, gear shift levers 38, arm rests 39, side window adjusters 40, speakers 42, lights 44, wireless chargers 46, power points 48, audio/video ports 50 or any other console feature known in the art. Cup holders 36 may include standard, size adjustable, heating/cooling or any other cup holder 36 known in the art. Audio/video ports 50 may include USB, MP3, Mini-USP, headphone jacks or any other audio/video port known in the art. The fixed portion 22 may further include fixed portion features which allows an occupant to control the vehicle's 21 radio or temperature.

The fixed portion 22 may include a lid 52 hinged the fixed portion 22 to allow access to a fixed bin 54. The lid 52 may act as an arm rest 39 or cup holder 36 when in its closed position, but may be opened at a hinged portion to allow access to the fixed bin 54. The lid 52 may include a lid lock 56 that secures the lid 52 to the fixed portion 22. A lid release 58 may be utilized to release the lid lock 56 and allow the lid 52 to hinge open from the closed position. Additionally, a slidable cover or any other cover known in the art may be used.

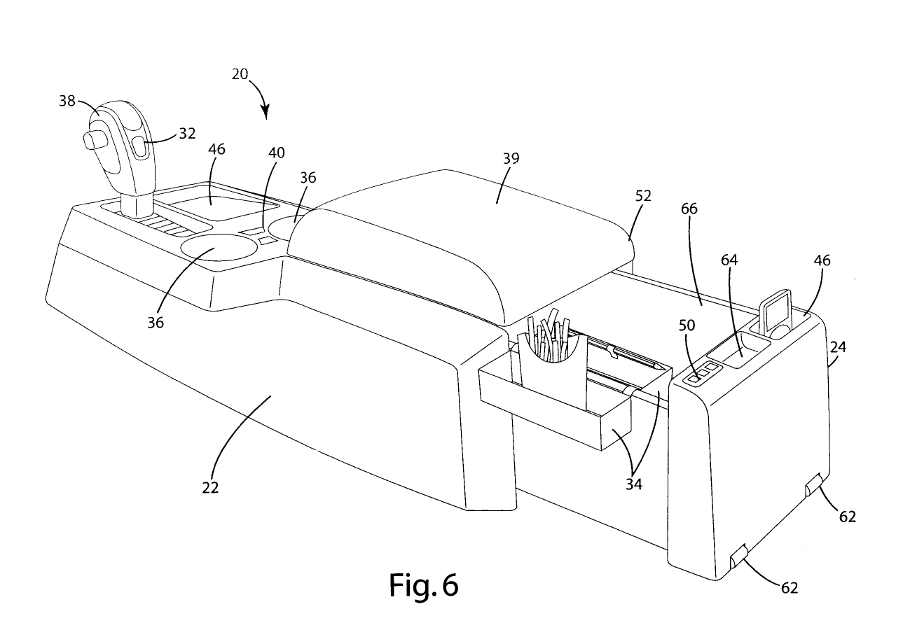

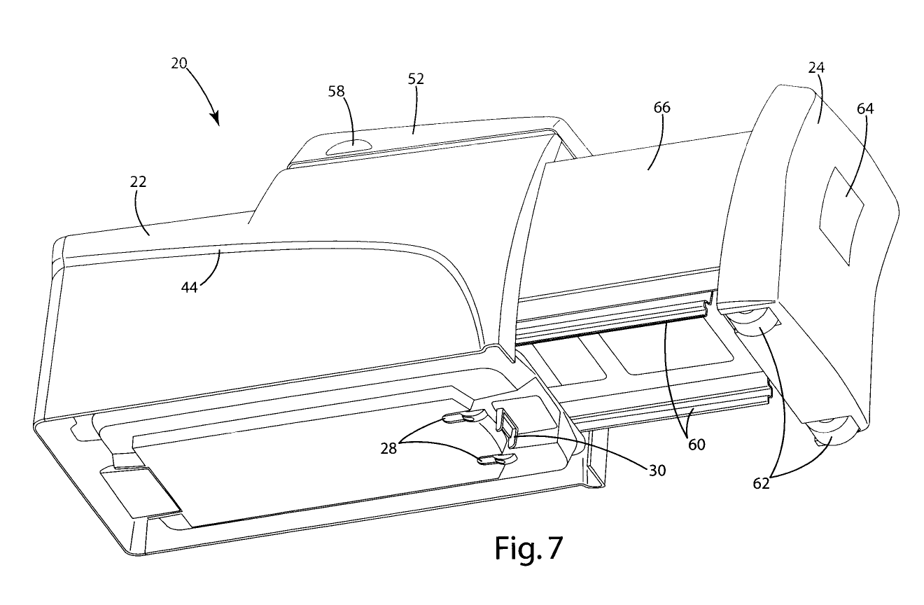

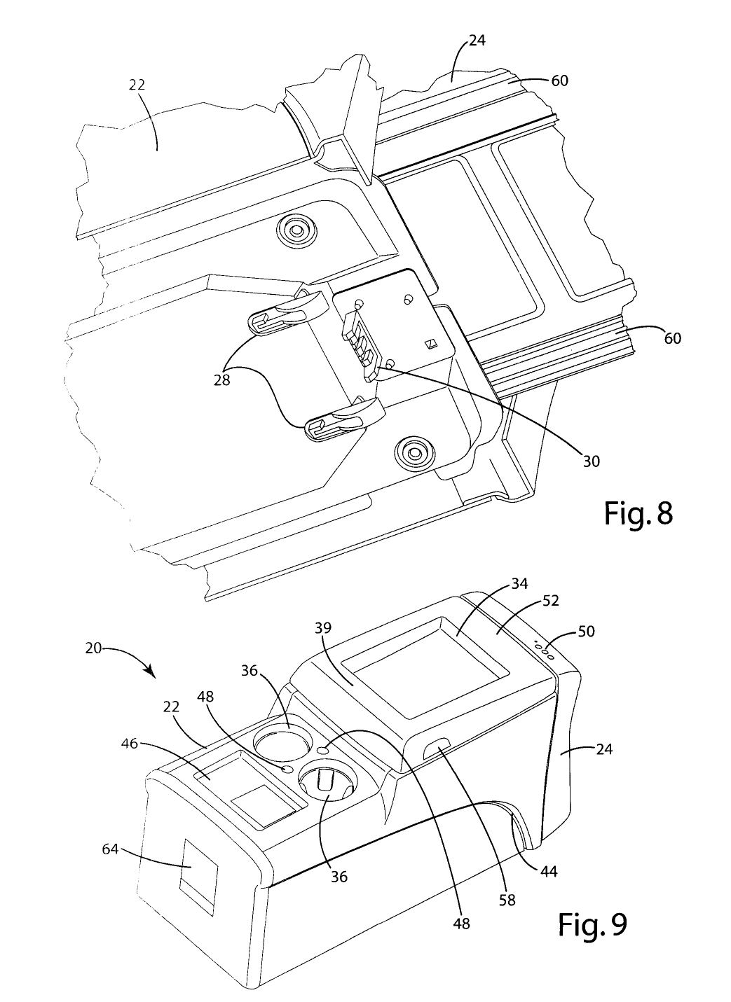

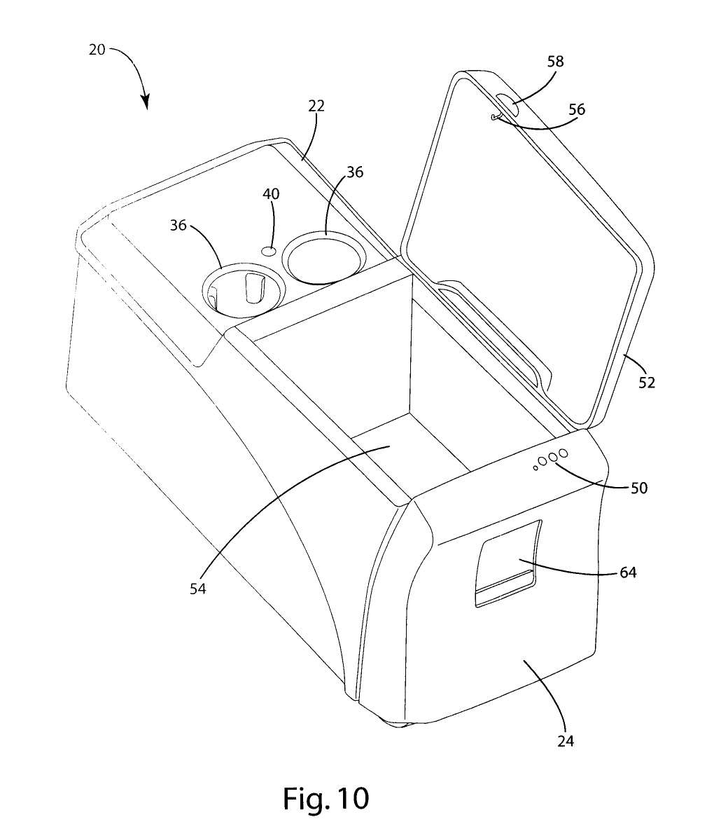

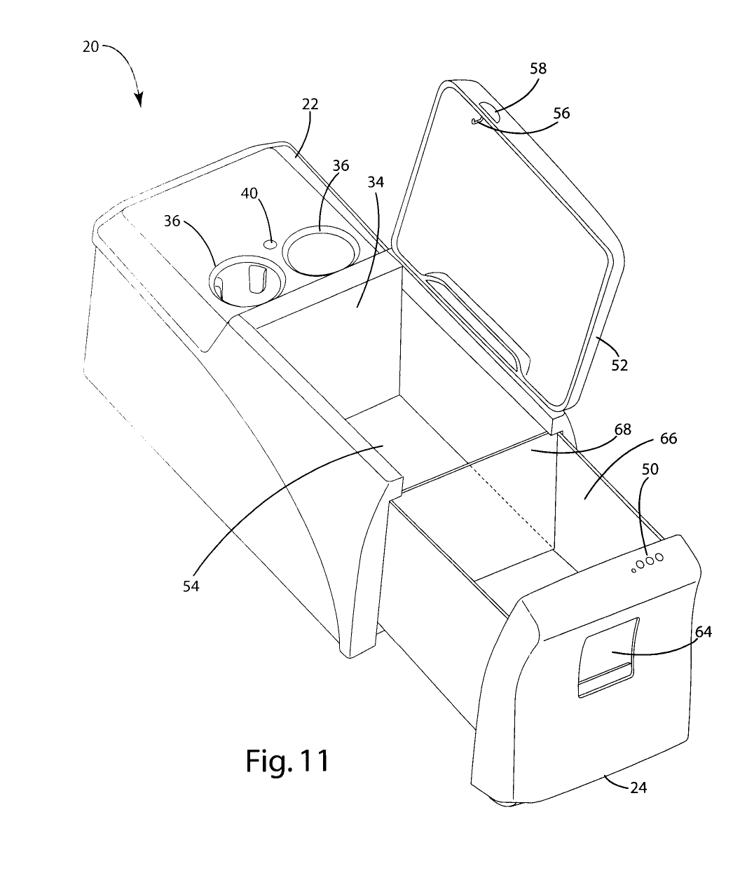

The sliding portion 24 is slidably mounted within the fixed portion 22 and moves relative to the fixed portion 22 along the longitudinal axis A as the sliding portion 24 moves in and out of the fixed portion 22. The sliding portion 24 is manufactured from any material known in the art, such as vinyl, leather, metal, cloth or plastic. In the exemplary embodiment, as shown in FIG. 6, the fixed portion 22 includes a first slide (not shown) that engages a second slide 60 secured to the sliding portion 24 to control the inward and outward movement of the sliding portion 24. The first slide and second slide 60 are disposed within the fixed portion 22 when the sliding portion 24 is in a forward position. The forward position is when the sliding portion 24 in as far into the fixed portion 22 as allowed by the console 20 design.

The sliding portion 24 further includes at least one wheel 62 disposed on the bottom of the sliding portion 24. The wheel 62 engages the surface material on the base 26 and allows for movement of the sliding portion 24 relative to the base 26. The wheel 62 acts as a support for the sliding portion 24 along the base 26 while minimizing friction between the base 26 and the sliding portion 24.

The sliding portion 24 includes at least one sliding console feature. Sliding console features include instruments 32, storage compartments 34, cup holders 36, gear shift levers 38, arm rests 39, side window adjusters 40, speakers 42, lights 44, wireless chargers 46, power points 48, audio/video ports 50 or any other console feature known in the art. The sliding portion 24 may be electrically connected to the fixed portion 22 for providing power to the sliding portion 24. Cup holders 40 may include standard, size adjustable, heating/cooling or any other cup holder 40 known in the art. Audio/video ports 54 may include USB, MP3, mini-USP, or any other audio/video port known in the art. The sliding console may further include sliding console features which allows an occupant to control the vehicle's 21 radio or temperature.

The sliding portion 24 may include a sliding lock that engages the fixed portion 22 to secure the sliding portion 24 to the fixed portion 22 when the sliding portion 24 is in the forward positions. The sliding portion 24 can be locked in multiple positions from a full forward position to a full rearward position. The sliding portion 24 may further include a release handle 64 to release the sliding lock and allow the sliding portion 24 to move away from the fixed portion 22.

The sliding portion 24 includes a sliding bin 66 as the sliding portion 24 moves away from the fixed portion 22. The fixed portion 22 may include a wall 68 that divides the fixed bin 54 from the sliding bin 66 as the sliding portion 24 moves away from the fixed portion 22. The sliding bin 66 may further include a sliding cup holder 70 that extends from the sliding bin 66. The sliding bin 66 may further include a cover disposed over the sliding bin 66 that prevents things from falling into the sliding bin 66 when slid out. The cover may be a slidable cover or any other cover known in the art.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A vehicle console for simultaneously providing console features to multiple rows of occupants of a vehicle comprising:
a fixed portion having at least one fixed console feature; and
a sliding portion slidably mounted within said fixed portion for movement relative to said fixed portion and having at least one sliding console feature.

2. The console as set forth in claim 1 wherein said fixed portion includes a first slide and said sliding portion includes a second slide engaging said first slide for allowing movement of said sliding portion relative to said fixed portion.

3. The console as set forth in claim 2 wherein said first and second slides are disposed within said fixed portion when said sliding portion is in a forward position.

4. The console as set forth in claim 1 further including a base for securing said fixed portion to and wherein said sliding portion includes at least one wheel disposed on the bottom of said sliding portion for engaging said base and moving said sliding portion along said base.

5. The console as set forth in claim 4 wherein said wheel does not engage a track disposed on said base.

6. The console as set forth in claim 1 wherein said sliding portion includes a sliding lock for engaging said fixed portion to secure said sliding portion to said fixed portion when said sliding portion is in a forward position.

7. The console as set forth in claim 6 wherein said sliding portion includes a release handle for releasing said sliding lock to allow said sliding portion to move relative to said fixed portion.

8. The console as set forth in claim 1 wherein said at least one fixed console feature is at least one of instruments, storage compartments, cup holders, gear shift levers, side window adjusters, speakers, lights, wireless chargers, power points and audio/video ports.

9. The console as set forth in claim 1 wherein said at least one sliding console feature is at least one of instruments, storage compartments, cup holders, gear shift levers, side window adjusters, speakers, lights, wireless chargers, power points and audio/video ports.

10. The console as set forth in claim 1 further including a base for securing said fixed portion to and wherein said fixed portion includes at least one latch extending from the bottom of said fixed portion for engaging said base to secure said fixed portion to said base.

11. The console as set forth in claim 1 further including a base for securing said fixed portion to and wherein said fixed portion includes an electrical connector extending from the bottom of said fixed portion for engaging said base to provide power to said fixed portion.

12. The console as set forth in claim 11 wherein said sliding portion is electrically connected to said fixed portion for providing power to said sliding portion.

13. The console as set forth in claim 1 wherein said fixed portion includes a lid hinged thereto for allowing access to a fixed bin.

14. The console as set forth in claim 13 wherein said lid includes a lid lock to lock said lid to said fixed portion.

15. The console as set forth in claim 14 wherein said lid includes a lid release for releasing said lid lock and allowing said lid to hinge open from said fixed portion.

16. The console as set forth in claim 13 wherein said sliding portion includes a sliding bin as said sliding portion moves away from said fixed portion.

17. The console as set forth in claim 16 wherein said fixed portion includes a wall for dividing said fixed bin from said sliding bin as said sliding portion moves away from said fixed portion.

18. The console as set forth in claim 16 wherein said sliding bin includes a sliding cup holder extending from said sliding bin.

19. The console as set forth in claim 1 wherein the vehicle is one of a automobile, plane or train.

20. The console as set forth in claim 1 wherein said fixed and sliding portions are manufactured from at least one of vinyl, leather, metal, cloth or plastic.

21. A console for simultaneously providing console features to multiple rows of occupants of a vehicle comprising:
a fixed portion having at least one fixed console feature;
a sliding portion slidably mounted within said fixed portion for movement relative to said fixed portion and having at least one sliding console feature;
a sliding lock extending from said sliding portion for engaging said fixed portion to secure said sliding portion to said fixed portion when said sliding portion is in a forward position; and
a release handle for releasing said sliding lock and allowing said sliding portion to move relative to said fixed portion.

22. A console for simultaneously providing console features to multiple rows of occupants of a vehicle comprising:
a fixed portion fixed to a base and having at least one fixed console feature;
a sliding portion slidably mounted within said fixed portion for movement relative to said fixed portion and having at least one sliding console feature;
at least one wheel disposed on the bottom of said sliding portion for engaging said base and moving said sliding portion along said base; and
wherein said wheel does not engage a track disposed on said base.
